(19) United States
(12) Patent Application Publication
(10) Pub. No.: US 2026/0105547 A1
(43) Pub. Date: Apr. 16, 2026

(54) Virtual Waiter

(71) Applicant: Conceptic LTD., Masad (IL)

(72) Inventor: Adi Chitayat, New York, NY (US)

(21) Appl. No.: 19/358,758

(22) Filed: Oct. 15, 2025

Related U.S. Application Data
(60) Provisional application No. 63/707,259, filed on Oct. 15, 2024.

(51) Int. Cl. G06Q 50/12

(52) U.S. Cl. CPC G06Q 50/12

(57) ABSTRACT

A system including: a processing unit; at least one camera with a field of view (FOV) of a dining area, the at least one camera being in communication with the processing unit; a digital menu device, including a user interface, a display, a memory a processor, and a wireless communication component; and a cloud-based machine learning (ML) service, comprising: a plurality of computing nodes communicatively coupled over a network, and at least one model deployment module configured to host a trained model as a cloud service; wherein the digital menu device configured to selectively communicate wirelessly with the processing unit and the cloud-based ML service; and wherein the cloud-based ML service configured to provide model inference in response to remote client requests from the processing unit and digital menu device.

This patent application claims priority from, and the benefit of, U.S. Provisional Ser. No. 63/707,259 , filed Oct. 15, 2024, which is incorporated in its entirety as if fully set forth herein.

### FIELD OF THE INVENTION

The present invention relates to a system combining a menu with an AI assistant and other peripheral components, and more specifically to a menu with an AI assistant that also combines local (e.g., cameras) and cloud-based resources to provide a streamlined, efficient, and user-friendly service to restaurant patrons.

### BACKGROUND OF THE INVENTION

The Applicant is a leading company in the space of tablet menus for full-service restaurants (i.e., without a self-ordering feature) and among the issues encountered is a difficulty in promoting dishes and suggesting food and drink items with no accurate ability to measure the impact of the promoted dishes or suggested items. As such, the company has not been able to accurately measure the impact of the recommendations and suggestions or to optimize them.

On POS systems, one is able to tell what was ordered at a specific table, but not which dish was ordered by each patron. In some high-end restaurants they do record which seat at the table ordered which dish, but then there is no way to tell from the seat number which tablet was used. For example, a table of 8 people may order 8 appetizers and 8 entrees and each of the patrons may look on the tablet menu and see different promotions but there is no accurate way to tell which promotion was viewed vis-à-vis what was actually ordered.

Moreover, upgrading tablet menus by adding an AI based virtual waiter that can recommend dishes is challenging in a restaurant environment where Wi-Fi is not particularly powerful or stable, and dozens of tablet menus are connected to the local Wi-Fi.

### SUMMARY OF THE INVENTION

There is presently provided a solution that employs AI capabilities in Wi-Fi constrained environments with inadequate wireless coverage and/or over-used wireless networks.

According to the present invention there is provided a system including: a processing unit; at least one camera with at least a partial field of view (FOV) of a dining area, the at least one camera being in communication with the processing unit; a menu listing serving options and prices for a given establishment; a virtual waiter module embodied on a device including a user interface, a display, a memory a processor, and a wireless communication component; and a cloud-based machine learning (ML) service, comprising: a plurality of computing nodes communicatively coupled over a network, and at least one model deployment module configured to host a trained model as a cloud service; wherein the virtual waiter module is configured to selectively communicate wirelessly with the processing unit and the cloud-based ML service; and wherein the cloud-based ML service configured to provide model inference in response to remote client requests from the processing unit and virtual waiter module.

According to further features in preferred embodiments of the invention described below historical data includes datapoints including at least: browsing metadata from the digital menu, the Virtual Waiter Module, data from camera imagery of a serving received by a user of the Virtual Waiter Module, or a combination thereof.

According to still further features in the described preferred embodiments the datapoints are correlated into sets of related datapoints. According to still further features the datapoints further include at least one of: suggested modifications, environmental information, a profile of diners located at a same table as the user, and suggested combinations from the cloud-based ML service. According to still further features the datapoints are correlated into sets of related datapoints by the processing unit, by the ML service, or by a combination of the processing unit and the ML service.

According to still further features the ML service is further configured to receive the historical data and wherein the ML service further includes: at least one model training module executed on at least one of the computing nodes, configured to train an updated machine learning model using the received historical data as training data. According to still further features the trained model is replaced with the updated trained model.

According to still further features the ML service receives the historical data from at least one of: the digital menu device, the processing unit, a point-of-sale computer, the at least one camera. According to still further features the digital menu device connects to the cloud-based ML service over Wi-Fi.

According to still further features the wherein the virtual waiter module includes a navigation module configured to retrieve response data in response to a request from the user. According to still further features the virtual waiter module includes a local model deployment module hosting a pretrained machine language model. According to still further features the virtual waiter module includes a policy module configured to fetch historical data from a point-of-sale computer in order to determine a substitution policy. According to still further features the virtual waiter module includes a voice and/or face recognition module for identifying a user. According to still further features the virtual waiter module includes a database of responses to frequently asked questions (FAQs). According to still further features the virtual waiter module includes a listener module configured to detect and process audible instructions as policy.

According to still further features the virtual waiter module connects to the cloud-based ML service over Wi-Fi, cellular communications, or both Wi-Fi and cellular communications. According to still further features the menu is embodied on a paper menu, a tablet computer menu, or a personal mobile computing device. According to still further features the virtual waiter module is embodied on the tablet computing device or on a secondary computing device. According to still further features the

According to still further features the virtual waiter module on the secondary computer device is linked to the system via a digital linking mechanism, wherein the digital linking mechanism is selected from the group including, a QR code, a barcode, a Near Field Communications tag, a login code, and combinations thereof.

According to still further features the system further includes a linking mechanism for digitally linking a secondary computing device to the digital menu device, where the linking mechanism is further configured to link the secondary computing device to a dedicated application or website that interfaces with the cloud-based ML service.

According to another embodiment there is provided a method for providing a suggestion, the method comprising the steps of: providing the aforementioned system; receiving a query on the digital menu device; contacting the cloud-based ML service to understand the query if not understood; comparing the query to a database of frequently asked questions (FAQs) and output an answer of if the query matches one of the FAQs; engaging the cloud-based ML service if the query does not match any of the FAQs and requesting a model inference in response to the query; outputting the model inference on a user interface of the device on which the virtual waiter module is embodied.

### BRIEF DESCRIPTION OF THE DRAWINGS

Various embodiments are herein described, by way of example only, with reference to the accompanying drawings, wherein:

FIG. 1 is a pictorial representation of a number of elements of the eMenu concept according to an example embodiment of the present invention;

FIG. 1A is a diagram of the AI cloud with example modules;

FIG. 1B is a diagrammatic representation of modules that are included in the virtual waiter module;

FIG. 1C is a pictorial depiction of a personal smart device scanning a QR code displayed on a tablet menu device;

FIG. 2 is an example embodiment of a decision tree/process 200.

### DESCRIPTION OF THE PREFERRED EMBODIMENTS

The principles and operation of a virtual, AI-enabled waiter embodied on a /blet/ digital menu platform (in some embodiments with the option of direct ordering through the device and in some embodiments without an option to order from the digital menu, and in some embodiments the AI waiter is embodied on a personal computing device such as a smartphone) according to the present invention may be better understood with reference to the drawings and the accompanying description.

According to some embodiments, present invention is not intended to enable self-ordering via the Virtual Waiter (VW). Rather, the VW is meant to answer questions and help patrons make decisions about what to order (including providing recommendations), and the actual order will be done via a human waiter. This upgrade to the current solution (existing tablet computer menus) is to provide better customer service and speed up the time from seat to order, by providing an interface that can order all patrons' questions before the human waiter arrives at the table to take the order.

A second option is to order directly via the digital menu/tablet. A third option is to order via the Virtual Waiter. Any or all of these options can be used in combination, i.e., at least partially ordering via a human waiter, via the table menu device, and/or via the virtual waiter module. The virtual waiter may be installed on the tablet menu device or it may be installed as an app on the personal mobile device (e.g., smartphone) or it may be accessed via the internet on the personal mobile device.

One of the technical problems to overcome, according to some embodiments, is how to provide personalized assistance for ordering or before the waiter arrives to take the order, or both.

The purpose of the present solution(s) is twofold:
(a) To provide a dining experience where the patrons can interact with a virtual waiter (“VW”) who/that can “understand” the spoken word and/or understand the unique characteristics of the guests at the table (i.e., family, a couple in romantic dinner, group of 4 young men, etc.), answer questions about the menu (i.e., what is the most popular appetizer), answer particular questions about the kitchen policy in regards to the items on the menu (i.e., can I substitute the French fries with salad), provide suggestions (i.e., wine paring to a dish based on the wine selection at the restaurant), understand the patrons request (i.e., “can I have the Caesar salad without the parm?”—even though the word “parm” is not presented in the menu the VW will understand it is referring to “parmesan cheese”), and answer any question that a human waiter can answer, and many questions that even a human waiter cannot answer.

In some cases, the VW can learn what each patron eventually orders, even when it is not a self-ordering solution, and the order is done via a human server/3^{rd} party solution. According to some embodiments, the system functions as a personal waiter wherever the system is used, regardless of which restaurant or dining establishment the user is in. In these embodiments, the system builds a personal profile that can be applied in any establishment to serve as a virtual waiter.

The VW can also recognize a patron via voice recognition or via the camera or other classic login methods like Google™ login code to a cellphone and/or other well-known methods in the art.

Also, the virtual waiter (whether it is based on the tablet menu or on a guests'phone) learns from past tablet menu usage data (customer's journey), establishment camera analysis (who the patrons are at the table, what each person actually gets on his/her plate), POS data, what recommendations work for which types of clients, and more. This allows the system to measure what recommendations actually work in order to improve the system's success rate in providing recommendations that the patrons follow and are happy with.
(b) Enable use of a virtual waiter in a real restaurant environment with the restaurant limitations such as, for example, limited/insufficient Wi-Fi access.

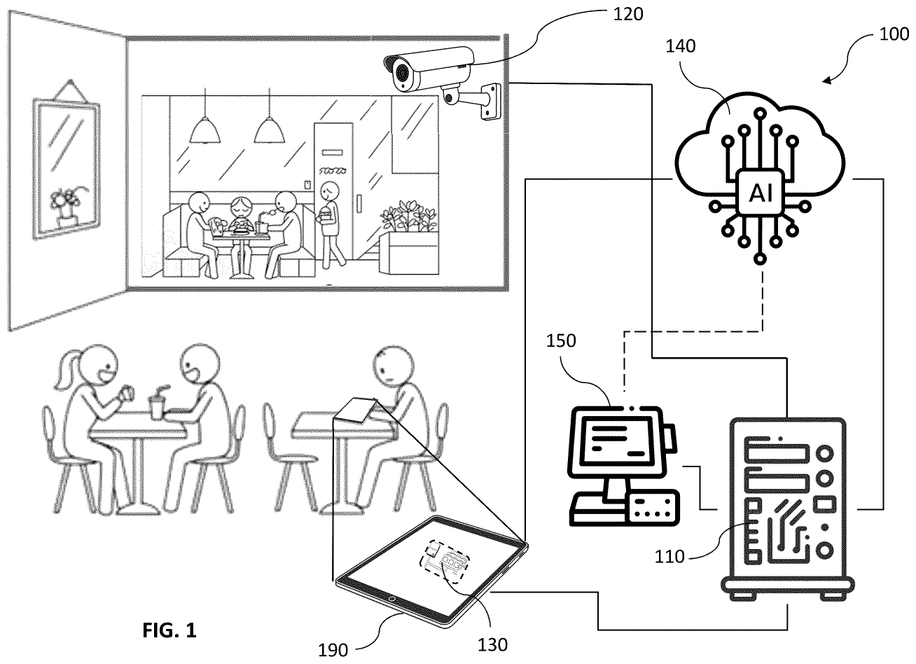

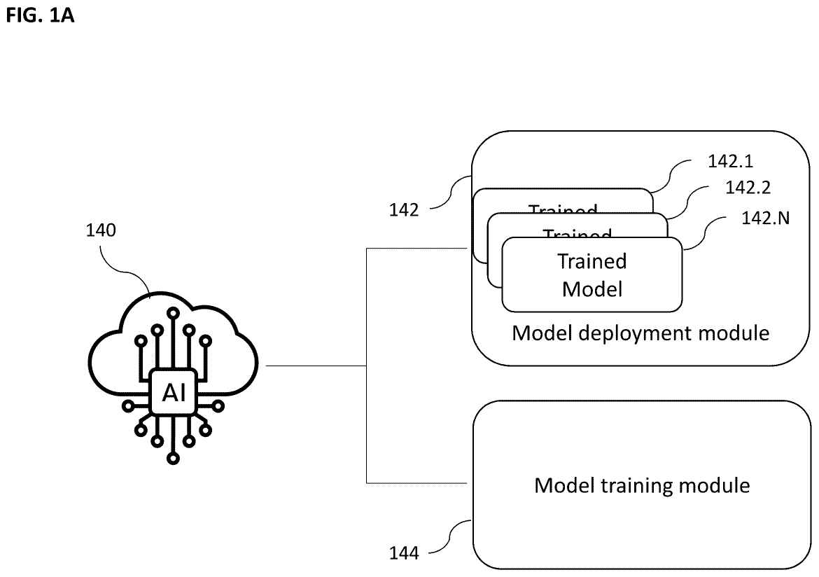

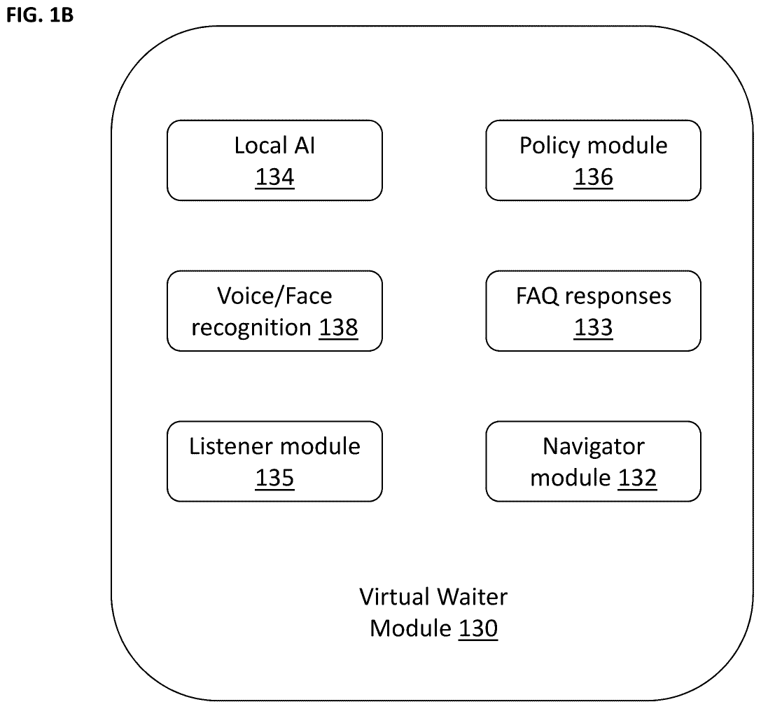

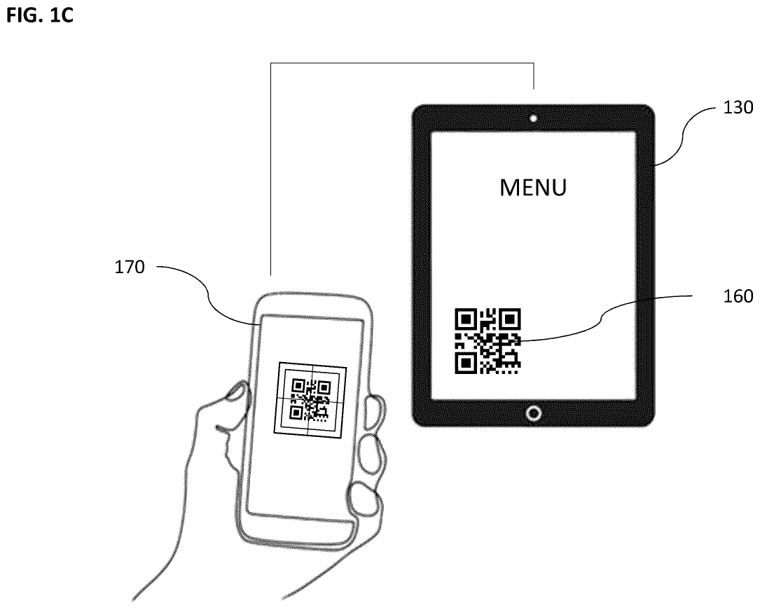

Referring now to the drawings, FIG. 1 illustrates a pictorial representation of a number of elements of the eMenu concept according to an example embodiment of the present invention. FIG. 1 depicts an example system 100 including a processing unit 110 such as a backend mainframe including, at least, a processor, memory, WiFi and internet communication capabilities, etc. The system includes at least one camera 120 with a field of view (FOV) of a dining area, where the camera or cameras are in communication with the processing unit/mainframe. In some embodiments, the ‘at least one camera’ may be, or may include, an embedded camera on the tablet menu or personal smartphone. In example embodiments, the system includes a point-of-sale computer 150, which records the orders placed by patrons, usually based on the table number.

Each patron or table is provided with at least one tablet computer 190 hosting a menu application. In some embodiments, a paper menu 190 is provided with a QR code (also referred to herein as a digital linking mechanism) printed on the menu. In some embodiments, a similar digital linking mechanism such as an NFC tag placed on the table or embedded in the physical menu. In such cases, the user's personal device is linked to the establishment's menu.

In addition to the menu, there is a Virtual Waiter module 130 that is embodied on a digital device. The digital device may be the same tablet with the menu application, i.e., both a digital menu and the virtual waiter module are on the same device. Alternatively, the digital device with the virtual waiter module may be the guest's personal mobile device which is linked to the establishment's menu and system via one of the aforementioned digital linking mechanisms (see FIG. 1C for an example implementation).

To summarize as well as completing the picture, there are four options for embodying the menu and virtual waiter (VW) module:
(1) the establishment's tablet menu+the VW module installed on the tablet menu;
(2) tablet menu+the VW module installed on a personal mobile device (e.g., linked by scanning a QR code displayed on the tablet);
(3) a paper menu (e.g., with a printed QR code or embedded NFC tag)+a VW module installed on a personal mobile device (and linked with the digital linking mechanism); and
(4) a personal mobile device (linked to the menu by a digital linking mechanism) hosting both the menu and the VW module.

To clarify, the term digital linking mechanism, as used herein, is intended to encompass any type of code that is scanned (e.g., barcode, QR code, and the like) or electronically actuated (e.g., NFC tag, BT device etc.)—hence ‘digital’—that causes or facilitates linking the mobile computing device to an application or website or web-application—hence ‘linking mechanism’—while also forming a link to the menu and establishment and system.

The device on which the VW module is installed is also referred to herein as a VW device. The VW device includes, at least, a user interface (touchscreen, camera, microphone, speakers, and the like), a display (e.g., touchscreen), a memory (in some embodiments, the memory/storage has stored thereon, inter alia, at least a local machine learning module with limited AI functionality), a processor, and a wireless communication component. As mentioned the VW device may be the same tablet with the menu application or may be personal smartphone.

A cloud-based machine learning (ML) service 140 is also part of the system. The cloud-based ML service is also referred to herein as an AI cloud and similar names. In an example embodiment, the AI cloud includes a plurality of computing nodes communicatively coupled over a network. FIG. 1A is a diagram of the AI cloud with example modules. In embodiments, the AI cloud includes at least one model deployment module 142 configured to host at least one trained model 142.1-142.N as a cloud service. The VW device is configured to selectively communicate wirelessly with the processing unit and the cloud-based ML service. The cloud-based ML service is configured to provide model inference in response to remote client requests from the processing unit and/or VW.

Model inference is the process of using a trained machine learning model to make predictions or decisions on new, unseen data. It is the phase after the model has been trained, where it is put into a production environment to process live input and generate an output.

In embodiments, the ML service further includes at least one model training module 144 executed on at least one of the computing nodes, configured to train an updated machine learning model using received historical data as training data.

Historical data, as referred to herein, includes sets of related data points. Data points refer to any data/metadata from the tablet, captured images from the cameras, processed images from the mainframe and/or AI cloud, POS records and any other data including data that was manually entered by a human waiter. An example of a set of related data points could include the browsing data from the tablet menu (which indicates what the user looked at prior to ordering, what pop-up suggestions appeared, and what VW suggestions were presented), imagery from the camera and/or data from image processing of the imagery (e.g., a profile of the diners and what meal/dish the user actually ordered) as well as any suggested modifications and/or combinations from the local and/or cloud-based ML service.

The ML service may receive the datapoints individually from various sources and perform the correlation process of connecting the datapoints into sets of related datapoints (e.g., what was browsed, what promotions were viewed, what was suggested and what was eventually ordered). Alternatively, or additionally, the correlation process may be performed, or partially performed, by the mainframe (processing unit 110) and then sent to the ML service. The historical data may be stored, for example, on a storage device coupled to the processing unit. Alternatively, or additionally, the ML service receives the historical data from at least one of: the digital menu, the VW module, the processing unit, a point-of-sale computer, the at least one camera.

FIG. 1B illustrates a diagrammatic representation of modules that are included in the virtual waiter module. In example embodiments, the Virtual Waiter Module 130 includes a navigator module 132 which is configured to retrieve response data in response to a request from the user. The Navigator module decides which of the following elements to involve, and to what degree to involve them, to generate an answer to the patron's questions.

In example embodiments, the Virtual Waiter Module 130 includes a local model deployment module (also referred to herein as a local AI) 134 hosting a pretrained machine language model.

In example embodiments, the Virtual Waiter Module 130 includes a policy module 136 configured to fetch historical data from a point-of-sale computer in order to determine a substitution policy.

In example embodiments, the Virtual Waiter Module 130 includes a voice and/or face recognition module 138 for identifying a user from his or her voice by matching the voice to a previous user. Once identified, the previously recorded preferences for that user can be accessed for use in providing suggestions now.

In example embodiments, the Virtual Waiter Module 130 includes a database of responses 133 to frequently asked questions (FAQs). In example embodiments, the digital menu device has stored thereon a listener module 135 configured to detect and process audible instructions, e.g., from the chef or GM, and store those instructions as policy.

The aforementioned components, features, and functionality are discussed hereafter in a more detailed fashion:
1. Tablet Menu—menu on a tablet that presents visuals of the food (videos and/or images) where the language can be changed.
2. Cloud-based AI that can “understand the intent of the patrons”: i.e., if a patron asks if there is parm in the taco, the AI can understand that by saying “parm”, the patron means “parmesan cheese”. Also, the AI can provide high-quality, well-phrased answers.
3. Access to the POS data to determine the kitchen policy based on past orders: i.e., if in the POS data in the last 3 months, the rice was substituted with yellow/brown rice at no cost, then the VW will provide a positive reply to this type of question.
4. Locally limited AI that is saved on the tablet will not provide as high-quality results as the cloud-based AI since the AI on the tablet does not have enough memory (compared to Cloud-based AI), and the CPU is limited compared to cloud-based AI (an explanation for the reasoning behind having this limited AI saved locally will be presented below). It is noted that in embodiments where a secondary smart device is used, the local AI component may not be necessary or used.
5. A set of answers to the most popular questions which is saved locally on the tablet.
6. Image analysis of the restaurant cameras to provide:
A. The characteristics of the patron or patrons to the virtual waiter (couple, four young males in their late 20s, etc.).
B. Provide input to help connect the data points and analyze data-what dishes were browsed on a certain tablet (e.g., the tablet provides this information directly), the characteristics of a certain patron, what was recommended to the patrons and what s/he asked about, versus what they eventually ordered (camera feed analysis can tell, out of the items that were ordered to the table, what was delivered to the specific patron).
7. The VW includes a Listener module that listens to the daily brief by the chef / restaurant general manager about the daily specials and promotes these specials to the patrons in a similar way to how human waiters would promote them.
8. The VW can use voice recognition to cross-reference data with previous encounters with the same patron, including what he actually ordered in previous encounters (in all restaurants that use the instant system), what suggestions he received, and what promotions he saw.
9. The system can analyze what recommendations and promotions were seen by the patron, what suggestions were made by the VW, and what the patron actually received in the end, thereby learning and improving its success rate with the recommendations it provides.

Today, via the POS, you can tell what items were served to a particular table but not to what each patron ordered. With the present system, it is possible to match each diner's order with the person, and cross-reference which tablet they used, thereby being able to mine the tablet data and correlate between what was perused on the eMenu and what was eventually ordered. For example, if you have 6 people at a table, the system knows, via the POS data, what was ordered at the table; the system, via the tablet data, knows what the people at the table were looking at. Innovatively, with the image analysis (using the restaurant camera footage), the system can correlate what each specific person looked at on the tablet eMenu, what questions were asked to the VW, and what the patron eventually received at his/her plate (i.e., what they ordered) via image analysis.

One of the primary objectives of the instant system is to generate a set of training data to train LLMs/ML models/AI by correlating what was browsed on the digital menu (tablet menu and/or QR code enabled app on personal smart device) and what was finally ordered (and/or what was not eaten and/or what was lauded or complained about on social media).

The present system importantly integrates the restaurant's cameras. This serves two important goals: (1) Guest recognition—identifying who is seated at the table in order to better tailor food and drink recommendations; and (2) Meal recognition—identifying what each guest actually received, to evaluate and refine the AI waiter's recommendation success rate. It is important to note that some meals or dishes cannot be completely identified by image processing. For example, a beef burrito is indistinguishable from a chicken burrito or a cheese burrito. However, the complementary data, i.e., the additional datapoints from other sources such as the POS or the AI waiter module or the digital menu, all reduce the possibilities of what the specific dish could be and increases the system's ability to accurately identify the dish.

Currently, the AI waiter knows what it recommends (and in embodiments where the digital menu and/or the VW actually places the order, the system knows what was ordered to the table), but still does not necessarily know what each individual guest at the table ultimately receives. By integrating with the restaurant's cameras, the AI waiter can analyze who received what, compare this with its recommendations, and continuously improve how it suggests and pitches items.

For example, if the AI waiter recommended a cocktail to a female guest and she ordered it, while another male guest chose something the system did not recommend, the AI can analyze both outcomes. Over time, this allows the system to understand which recommendations resonate with which demographics, adjusting pitches accordingly. Similarly, by identifying who is at the table (gender, approximate age, group profile), the system can customize its approach—e.g., recommending different cocktails to a group of young women versus a group of men in their 50s.

Another element is integration with the POS system 150. If a guest requests something not on the standard menu (e.g., “Can I add salmon to the salad? ”), the AI waiter can check whether this has been ordered before, verify the additional cost, and respond immediately: “Yes, you can add salmon—it will be an additional $12 on top of your $20 salad.” If the AI waiter cannot find an answer, it can seamlessly text the general manager for assistance.

The combination of these elements—AI waiter software, the eMenu tablet, Restaurants'cameras (or any other camera: guest phone), and POS system—is what creates powerful and comprehensive AI waiter service. In one example embodiment, in order to correlate between a menu and a user, the system employs computer vision to process the captured imagery of FOV of the cameras to see who is holding which menu device by cross-checking time stamp of when the device was activated and matching the timestamped action to image of the user opening/activating the menu. If the user's phone is being used, then, for example, the login time or activation time of the mobile app is used for cross-referencing.

In embodiment, the AI waiter is presented directly on the eMenu tablet itself. In other embodiments, AI waiter is not presented directly on the eMenu tablet. The guests can, for example, scan a QR code from the tablet menu, launching the AI waiter (web-based application or downloadable app) on their own phone. The AI waiter can then guide guests through the dishes displayed on the digital menu. Thanks to direct communication between the AI waiter and the eMenu APP on the tablet, items can be highlighted in real time.

Example: A guest asks for sweet and fruity cocktails. The AI waiter responds: “Please open the cocktails category—I've marked three cocktails on the tablet menu that match your preference.” When the guest navigates to cocktails, they immediately see those three items highlighted. This seamless interaction shows the communication between the AI waiter (on the phone) and the eMenu (on the tablet).

The AI systems (the term “AI” being used generically herein to include all types of AI and ML models) may also employ other capabilities as well. For example, AI models for computer vision are also integral to the present system.

What follows is a short exposition of one branch of AI that relates to computer vision. Some of the types of models commonly used include:
A. Convolutional Neural Networks (CNNs)-CNNs are designed to process visual data by detecting patterns such as edges, textures, and shapes. They are generally used for image classification (e.g., “This image is a cat.”).
   Examples of architectures include, but are not limited to: LeNet™ (early CNN for handwritten digits), AlexNet™, VGGNet™, ResNet™ (uses “skip connections” to go deeper without losing performance), and EfficientNet™ (balances accuracy and efficiency).
B. Object Detection Models (built on CNNs)-These not only classify what objects are present but also where they are (bounding boxes). Examples include, but are not limited to: R-CNN™, Fast R-CNN™, Faster R-CNN™—region-based detectors; YOLO™ (You Only Look Once)—fast, real-time detection; SSD™ (Single Shot MultiBox Detector)—efficient and mobile-friendly; RetinaNet™—improves detection of smaller/less common objects.
C. Transformer-Based Vision Models—Recently, Vision Transformers (ViTs) and hybrids like DETR (DEtection TRansformer) have become popular. These are used for image classification and object detection with global attention. They can learn relationships between parts of an image better than CNNs alone.
D. Segmentation Models (for fine-grained object recognition)—Instead of just bounding boxes, these models label every pixel. Some example include: U-Net™, Mask R-CNN™, DeepLab™.

The virtual waiter module is essentially an interactive real-time recommender system which is an AI-based system that dynamically suggests content, products, or actions to users while continuously adapting to their feedback and behavior as it happens. Typical AI models used in such systems include, but are not limited to, (a) Contextual Bandits or Reinforcement Learning—to balance exploration (trying new things) and exploitation (showing what's likely to work); (b) Graph Neural Networks (GNNs)—to model relationships between users and items; (c) Sequence Models (Transformers, RNNs)—to capture short-term user intent in sessions; and (d) Hybrid Systems—combine collaborative filtering+content-based+contextual signals.

It is noted that this short, partial exposition relates to just one branch models that are related to computer vision. Other branches and models, known in the art, are also included within the scope of the invention for the various features and functionalities discussed herein.
10. The VW may include a Navigator module which is a component that decides which of the above elements to involve and to what degree to generate an answer to the patron's questions. The goal is to balance optimizing the quality of the reply and minimizing the use of the Internet.

For embodiments in which only the digital menu is used to access the AI cloud, or in cases where the personal smart device also uses the local Wi-Fi, one of the challenges is the limited Wi-Fi resources in a restaurant environment:
1. In one example embodiment, the instant solution is meant to work on a tablet that presents the actual restaurant menu: on the same tablet menu, there is the menu and the virtual waiter.
2. This means that a restaurant with, for example, 60 tablet menus will have on each tablet menu a Virtual server, leading to at least some of the following challenges:
   a. Today's restaurants have poor Wi-Fi connections, which will be challenged if all 60 tablets reach out to an AI server on the cloud seeking answers to patrons'questions.
   b. Efficiency and cost wise—taking a broader view—when thousands of restaurants with tens of dozens of tablets are reaching out to the AI on the cloud during the same busy hour (e.g., the dinner rush) seeking answers to patrons'questions, the cost of these transactions will be high, the load on the server will be high, the response time will be longer, and the efficiency will be low.

To clarify why this concept remains innovative even when each guest has their “own” AI waiter available on a tablet or smartphone, consider the following scenario:

In a full-service restaurant, at one table there can be multiple simultaneous interactions with multiple AI waiters. Some guests may request recommendations directly from their personal AI waiter but, when it comes to placing the order, they might do so in front of one or more other AI waiters. In other cases, a guest might join the conversation of the person next to them, so that both interact with a single AI waiter and place their order via this specific AI waiter. Two or more guests might decide to share a dish, but only one of them will actually place the order with the AI waiter.

There can also be a combination of these types of situations. In all cases, the core challenge remains: the system cannot know which recommendations influenced which guest or person (e.g., gender, age) without being able to track how decisions are made. A guest might be persuaded by a promotion on the tablet menu, another by their AI waiter's suggestion, and another by both. The true influence can only be measured once the food is served and the system matches each dish (or shared dish) to the specific guest(s). At that point, the system can trace back which recommendations drove which choices.

Example: A couple with children is dining at the table. Each adult interacts with their own AI waiter. Meanwhile, one of the children browses the tablet menu, sees an ice cream, and asks the adults to order it. One of the adults then instructs their AI waiter to add the ice cream to the order. In this case, we still require a “food-to-person recognition” element to connect the dots between what the child was browsing on the tablet and the order ultimately placed by the adult.

The present solution is focused on making this concept workable in today's restaurant environment.

### Clarifications Through Examples

Example 1—For questions like, “Can I substitute the French fries with a salad for this dish?” (The VW can know what the patron is looking at on the tablet menu, so it can tell what the patron is referring to), the main engine will pull the info from the FAQ preset list stored locally (on the individual tablet or local network server).

Example 2—For a question like: “Can I have a Caesar salad with no Parm?”, the engine will use the local AI model to determine that “Parm” means parmesan to reply and then reach out to a cloud server to analyze past purchases and see if this modifier was placed on the POS in the past X number of months.

Example 3—For a request such as: “Please pair me a New-World red wine with my dish,” the main engine will reach out to cloud AI with the list of the 600 wines available on the restaurant wine list and the name of the dish the patron was looking at on the tablet menu and request a pairing based on the guest's request.

Example 4—For a request such as: “I am allergic to turmeric, please suggest a dish without turmeric.” The system will contact the cloud-based AI with the menu list to get feedback and remove all curry dishes as well as other dishes with curry powder/curry flavor from the recommendations. The assumption being that any dish with curry flavoring will have turmeric in it. A more thorough filter could be “remove any dish with turmeric in it”. However, that kind of specific filter would only work if the menu included all the ingredients for each dish—which menus do not actually have. What menus do have is either curry in the name of the dish or a mention of the curry flavoring in the explanation of the dish. The AI has the data from the menu itself as input, to be able to provide accurate responses. It is also made clear that the AI is not being used as a tool to ensure that the patron is not being served something they are allergic to. That would be up to the waiter to check with the kitchen staff once a selection has been made. Here the AI assists in streamlining the ordering process by filtering out obvious dishes that the diner would not be able to order, due to the allergy.

Example 5—For a question like: “What cocktail can you recommend for me?” where there are, for example, four young women at the table. The Navigator will use the information coming from the tablets that are assigned or registered to the specific table, cross-referencing this information with image analysis of the video feed from the restaurant's cameras (based on the tablet timestamp and the camera time stamp both can be synchronized, or in real time), which uses AI to profile the number, gender and age of the group at the table. Based on the information gathered, the VW can reply, something along the lines of: “These are the three most popular cocktails that young women order in this restaurant”. This is a response that is similar to what a human waiter can understand at a second's glance at the guests at a table.

Example 6—For a request such as: “What soup do you recommend for me today?”, the Navigator will use past data to make a proposal. The ‘past data’ includes similar situations, such as people with similar characteristics who looked at certain things on the menu and then ordered something related. For example, if an elderly woman was looking at noodles on the tablet menu, but eventually ordered noodle soup (i.e., based on image analysis, the system correlates that out of all the people at the table, it was the elderly woman who received the soup), and this happened a few times, creating a pattern, the VW will say (or make the analysis) “I noticed that women who were interested in the noodles category, like you are, and then ask for a soup recommendation usually end up ordering the noodles soup. However, when the weather is above 55, like today, many of the women who asked me for recommendations for soup, eventually ordered noodle salad. Do you want to try that?” (and on the tablet, the system will open the noddle salad page with image of the food item and description).

The goal of these multiple optional answers is to limit the use of the restaurant's Wi-Fi, which is a bottleneck. The reason for a limited AI that is installed locally is that the tablet CPU is too weak for heavy AI use, and the space on the tablet is also very limited compared to the servers, which can hold an extreme amount of data to provide accurate info.

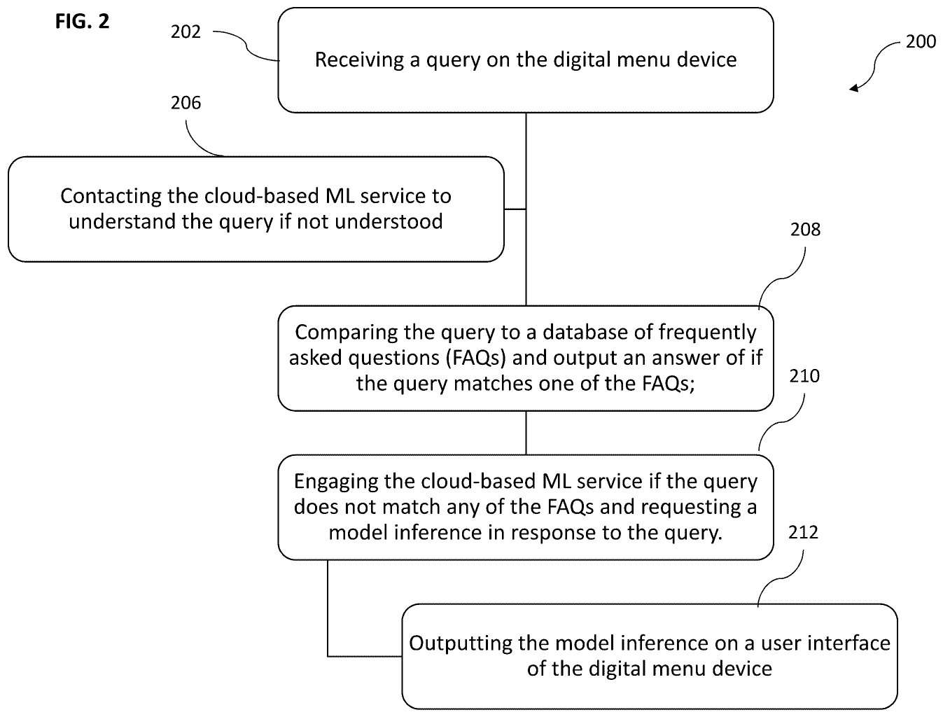

The examples above provide potential rules that a Navigator module could follow. FIG. 2 illustrates an example embodiment of a decision tree/process 200:

Step 202 Receive query from user. This may be written, spoken, or otherwise conferred by the user.

Is the query understood? If not, then go to step 206. If yes, proceed to step 208.

Step 206 Engage AI language model on the device to understand the question (See Example 2).

Step 208 Compare the question to the answers stored in a FAQ database (on the local storage device, like in Example 1). Is the answer in the database? If yes, go to step 212. If the answer is no go to step 210.

Step 210 Engage cloud server over Wi-Fi connection. The virtual waiter module requests a model inference from cloud-based ML service in response to the query. The cloud server employs AI and machine learning (ML) models that are generative, in that they generate text or other outputs and are trained or pre-trained on datasets/data sources.

Step 212 Output the response/suggestion (model inference) from the AI cloud on the menu device or the secondary computing device on which the virtual waiter module is embodied.

For example, the datasets may include data from the POS (e.g., to determine if something has a charge or is free of charge—see Example 2), the establishment's inventory (e.g., to know if some ingredient is in stock or not), the menu list and datasets relating to the preparation of the dishes on the menu (so that the AI can decide/predict if a given ingredient is used in the preparation of certain dishes—see Example 4).

In Example 3, the cloud AI can take a list of wines and the name of the dish and suggest which wine would be the most appropriate by accessing LLMs that have been trained, inter alia, on training data relating to food and wine pairings. This example can be generalized for any pairing or combination of food and/or beverages.

Additionally, the AI components available to the cloud server include computer vision AI/ML models for the purpose of image processing (e.g., to create a profile of diners at a table and/or for analyzing the nexus between the tablet information and the camera imagery captured by the restaurant cameras—Example 5).

The AI/ML models also generate the suggestions based on the profiles of the people and/or historical data (training data) generated by the system by analyzing the aforementioned nexus between tablet information and captured imagery from the restaurant cameras (example 6).

The system is iterative and recursive with each new data point being added to the dataset from which the AI/ML is trained to provide suggestions. So, for example, in Example 6, the first use of the computer vision is to profile the patrons at the table using trained AI for computer vision and profiling the age/gender of the group. Next the system registers what the patron is looking at on the tablet. If one person ordered a dish/meal and two people share it it is important to process what suggestions from the device—if any—influenced the decision making.

The system now goes to the AI/machine learning model trained on historical data of the nexus between what was looked at on the menu and what was eventually ordered. Based on this dataset, the AI makes a prediction which is converted into a suggestion. Additional environmental or other datapoints (such as the weather) may also be included in the training data.

In some embodiments, social media posts about the experience with a particular dish or combination may also be included in the training data. For example, a social media post that is found on the establishment's website or on social media sites but includes the name of the establishment, where the post or comment mentions a dish or certain combination, can be included in the dataset.

Step 212 Present a suggestion/response on the user interface. The response may be written in words on the GUI of the tablet (or personal smart device), outputted audibly, and/or provided as an image on the screen.

For example, the digital menu (also referred to herein as an eMenu) may open to the digital page of the menu where the dish is presented. The digital menu usually includes a presentation picture with the dish or combination dish/meal displayed together with all the components of the dish/meal. For example, a breakfast includes an omelet, bread, one hot drink, one cold drink and six dips. The pictured serving shows only one variation of the breakfast option. However, various substitutions can be made. For example, the omelet can be replaced with two eggs sunny-side up, the bread could be replaced with a whole-wheat roll, or focaccia, etc. etc.

In embodiments, the user can select one of the components of the displayed meal presentation and the AI waiter will recognize which element of the picture the user is selecting and then suggest the options for substitution. In some cases, the user selects an option from a drop-down menu, and the selected substitution is actually displayed—possibly even from an AI-generated picture, if no relevant picture is available in the system's database. This is a practical output that cannot be provided by a human waiter.

Together with the substitution features described above, or in place of such a feature, the system, via the menu GUI, can proceed to refine and/or change the suggested meal option by providing an option for input and then going back to Step 202.

For example, if a fish dish is initially selected (e.g., through the process of Steps 202-212), the interface can then prompt something along the lines of: “Would you like a wine to go with that?” Input is then received at Step 202. If it is understood, then go to step 208 otherwise engage the AI language model at step 206, before continuing on to step 208. If a stock suggestion is found in the database (e.g., in a FAQ section) then go to step 212 to output the response to the display and/or audibly. If a response is not readily available then the Navigator module may generate a profile of the patrons at the table, collect any relevant environmental and/or contemporary data (e.g., if there is special on a wine, if the GM told the staff that there are wines on inventory that have not been sold and that they should try suggest them, etc.) and then query the AI cloud for a prediction/suggestion based on one or more of the profile of the patrons, the already selected fish dish, and training data taken from historical information gathered from the nexus of data discussed above. The use of WIFI and/or the AI cloud is minimized using the aforementioned process and training dataset is improved with each use of the system.

The aforementioned notwithstanding, in some embodiments, the instant system can also be employed with an ‘only cloud-based AI’ configurations (i.e., the AI element is not installed on the tablet). The cloud-based-only option has some more example configurations: (1) using a mobile app on a personal smart device, (2) using a web-based application on a personal smart device, or (3) a mobile app with an i-frame “window” to show webapp, showing the AI waiter there. For example, in FIG. 1C, the digital menu includes a QR code 160 (or similar indicia) that the user can scan with their personal smart device (also referred to herein as a secondary computing device) 170 which will redirect or link to a virtual waiter website or to a downloadable application that can be installed on the personal device. One supposition is that personal smart devices, by default, use cellular connectivity as opposed to the restaurant's Wi-Fi, thereby eliminating the Wi-Fi bottleneck for AI cloud access discussed elsewhere herein. Even in cases where the user/patron already has the application installed on their device, scanning the QR code, for example, connects the Virtual Waiter session to the specific digital menu in the specific establishment. I.e., the virtual waiter now knows which restaurant the user is in and is linked to the specific menu the patron is using. The same process/configuration can be used for a paper menu or NFC tag.

### Personal Virtual Waiter

The virtual waiter, according to some embodiments, may not be linked so a specific menu or even to a specific establishment, but rather may be personal to the user. As the user uses the Personal VW in more and more establishments and situations, the better the PVW knows his/her preferences, as applied in different contexts. For example, the user may have one standard order when s/he is with the family, but a different preference or preferences when only going out with his wife/her husband and still a third preference, or set of preferences, when conducting a meeting over a meal. As mentioned above, the PVW may still need to link to a menu and/or establishment in order to give the best assistance to the user.

The present system is an improvement on kiosk or human waiter for at the following reasons: Computer/AI always remembers the person—once identified—and what they ordered each time; AI provides pattern recognition for repeat users, e.g., a user always orders the same thing, or even in cases where in the summer the user always orders one option and in the winter another option; Pattern recognition for all customers: such as (a) one or more of the options are never ordered, (b) specific dishes get favorable reviews and others do not; in extreme case the AI can check social media posts for personalization preferences. “you mentioned that at Jack Rabbit the Caesar salad had too much parmesan cheese—would you like us to go easy on the parm?”.

It is known in the art that some AI-driven Point-Of-Sale systems provide recommendations based on past POS purchases. However, these systems:
1. do not include video/image analysis to determine:
   a. the characteristics of the guests at the table;
   b. what was served to each quest at the table (dish image analysis); or
   c. the system is a kiosk, so if one person orders for a few people (like a family), the kiosk system cannot tell which person (with his / her particular characteristics: old, young, male, female, group dynamic, etc.) ordered which dish; and
2. do not deal with the challenges of poor wi-fi and broadband in restaurants when using dozens of tablet menus at the same time on the same system. In a restaurant, there are a few terminals or handhelds per number of waiters. Tablet menus are served to every guest seated in the restaurant, hence the high number of devices that use Wi-Fi for the cloud-based AI challenge. Also, unlike POS computers, which have more memory space and computing power, tablets have limited CPU power and space.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable non-transitory storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is

1. A system, comprising:
a processing unit;
at least one camera with at least a partial field of view (FOV) of a dining area, the at least one camera being in communication with the processing unit;
a menu listing serving options and prices for a given establishment;
a virtual waiter module embodied on a device including a user interface, a display, a memory a processor, and a wireless communication component; and
a cloud-based machine learning (ML) service, comprising:
a plurality of computing nodes communicatively coupled over a network, and
at least one model deployment module configured to host a trained model as a cloud service;
wherein the virtual waiter module is configured to selectively communicate wirelessly with the processing unit and the cloud-based ML service; and
wherein the cloud-based ML service configured to provide model inference in response to remote client requests from the processing unit and virtual waiter module.

2. The system of claim 1, wherein historical data includes datapoints including at least: browsing metadata from the digital menu, the Virtual Waiter Module, data from camera imagery of a serving received by a user of the Virtual Waiter Module, or a combination thereof.

3. The system of claim 2, wherein the datapoints are correlated into sets of related datapoints.

4. The system of claim 3, wherein the datapoints further include at least one of: suggested modifications, environmental information, a profile of diners located at a same table as the user, and suggested combinations from the cloud-based ML service.

5. The system of claim 3, wherein the datapoints are correlated into sets of related datapoints by the processing unit, by the ML service, or by a combination of the processing unit and the ML service.

6. The system of claim 2, wherein the ML service is further configured to receive the historical data and wherein the ML service further includes:
at least one model training module executed on at least one of the computing nodes, configured to train an updated machine learning model using the received historical data as training data.

7. The system of claim 6, wherein the trained model is replaced with the updated trained model.

8. The system of claim 2, wherein the ML service receives the historical data from at least one of: the digital menu device, the processing unit, a point-of-sale computer, the at least one camera.

9. The system of claim 1, wherein the virtual waiter module includes a navigation module configured to retrieve response data in response to a request from the user.

10. The system of claim 9, wherein the virtual waiter module includes a local model deployment module hosting a pretrained machine language model.

11. The system of claim 9, wherein the virtual waiter module includes a policy module configured to fetch historical data from a point-of-sale computer in order to determine a substitution policy.

12. The system of claim 9, wherein the virtual waiter module includes a voice recognition, face recognition, login, or voice and face recognition module for identifying a user.

13. The system of claim 9, wherein the virtual waiter module includes a database of responses to frequently asked questions (FAQs).

14. The system of claim 9, wherein the virtual waiter module includes a listener module configured to detect and process audible instructions as policy.

15. The system of claim 1, wherein the virtual waiter module connects to the cloud-based ML service over Wi-Fi, cellular communications, or both Wi-Fi and cellular communications.

16. The system of claim 1, wherein the menu is embodied on a paper menu, a tablet computer menu, or a personal mobile computing device.

17. The system of claim 16, wherein the virtual waiter module is embodied on the tablet computing device or on a secondary computing device.

18. The system of claim 17, wherein the virtual waiter module on the secondary computer device is linked to the system via a digital linking mechanism.

19. The system of claim 18, wherein the digital linking mechanism is selected from the group including, a QR code, a barcode, a Near Field Communications tag, a login code, and combinations thereof.

20. A method for providing a suggestion, the method comprising the steps of:
providing a system of claim 1;
receiving a query on at the virtual waiter module;
contacting the cloud-based ML service to understand the query if not understood;
comparing the query to a database of frequently asked questions (FAQs) and output an answer of if the query matches one of the FAQs;
engaging the cloud-based ML service if the query does not match any of the FAQs and requesting a model inference in response to the query;
outputting the model inference on a user interface of the device on which the virtual waiter module is embodied.
